(19) United States
(12) Patent Application Publication
(10) Pub. No.: US 2005/0173995 A1
(43) Pub. Date: Aug. 11, 2005

(54) Stator for reciprocating motor

(75) Inventors: Hyuk Lee, Siheung (KR); Sang-Sub Jeong, Seoul (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 11/030,090

(22) Filed: Jan. 7, 2005

(30) Foreign Application Priority Data
Jan. 10, 2004 (KR) 01794/2004

(51) Int. Cl. H02K 41/00; H02K 33/00; H02K 35/00

(52) U.S. Cl. 310/15; 417/417; 310/12

(57) ABSTRACT

A stator for a reciprocating motor comprises: a first stator provided with a winding coil; and a second stator inserted with a predetermined air gap from the first stator and molded by powder metallurgy. Fabrication processes can be simple and accordingly production costs of the reciprocating motor can be reduced sharply. In addition, the sectional area through which the flux passes is increased and the improvement of the motor efficiency can be expected.

### BACKGROUND OF THE INVENTION

1. Field of the Invention

The present invention relates to a stator for a reciprocating motor, and more particularly to, a stator for a reciprocating motor which is capable of improving the efficiency and productivity of the stator.

2. Description of the Background Art

In general, a motor is used as a core driving source for most electric and electronic goods such as a compressor, washing machine and electric fan and widely used in the industry as a whole. The motor serves to change electric energy into kinetic energy. Such a motor is various in types, and can be largely classified into rotary motor changing the electric energy into rotating movements and a reciprocating motor changing the electric energy into linear reciprocating movements.

Generally, it can be said that a reciprocating motor capable of realizing linear movements without any specific apparatus is more appropriate for the situation demanding linear movements.

One example of such a reciprocating motor is illustrated in FIG. 1. FIG. 1 is a sectional view showing one example of a conventional reciprocating motor. As illustrated therein, the conventional reciprocating motor includes a stator assembly 10 forming a flux and a mover assembly 20 performing linear reciprocating movements by the flux of the stator assembly 10.

The stator assembly 10 consists of an outer stator 11 formed in a cylindrical shape so as to be disposed in the outer side of the mover assembly 20 and an inner stator 12 formed in a cylindrical shape so as to be disposed in the inner side of the outer stator 11 with a predetermined core gap t.

The outer stator 11 is formed by laminating thin silicon steel sheets of a Π shape in a circumferential direction on the outer circumferential surface of a coil 30 of a ring shape generating a change of the flux.

The mover assembly 20 consists of a mover body 21 movably arranged in an air gap between the outer stator 11 and the inner stator 12 and a plurality of magnets 22 fixed on the outer circumferential surface of the mover assembly 21 with same intervals therebetween. Unexplained reference numeral 13 in the drawings denotes a fixed ring.

FIG. 2 is a perspective view showing an inner stator for the conventional reciprocating motor. As illustrated therein, the inner stator 12 is formed by laminating thin silicon steel sheets of a rectangular shape in circumferential direction.

Operations of the conventional reciprocating motor constructed as above will be described as follows.

When electric current is applied to the winding coil 30, the flux is formed around the winding coil 30. The flux forms a closed loop along with the outer stator 11 and the inner stator 12. At this time, since the magnet 22 of the stator assembly 20 is placed on the flux formed by the coil 30, the mover body 21 performs linear reciprocating movements as the magnet 22 is pushed or pulled along the direction of the flux by an interaction with the flux of the winding coil 30.

However, the inner stator of the conventional reciprocating motor has adopted the method of laminating thin sheets one by one in circumferential direction in order to reduce eddy current loss and increase the sectional area through which a flux passes. This method is difficult to manufacture and needs an excessive production cost.

### SUMMARY OF THE INVENTION

Therefore, an object of the present invention is to provide a stator for a reciprocating motor which can improve productivity and motor efficiency since it is easy to manufacture.

To achieve these and other advantages and in accordance with the purpose of the present invention, as embodied and broadly described herein, there is provided a stator for a reciprocating motor, comprising: a first stator provided with a winding coil and a second stator inserted with a predetermined air gap from the first stator and molded by powder metallurgy.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a sectional view showing one example of a conventional reciprocating motor;

FIG. 2 is a perspective view showing an inner stator for the conventional reciprocating motor;

FIG. 3 is a sectional view showing one example of a reciprocating motor according to the present invention;

FIG. 4 is a perspective view showing a second stator for a reciprocating motor according to a first embodiment of the present invention;

FIG. 5 is a perspective view showing a second stator for a reciprocating motor according to a second embodiment of the present invention;

FIG. 6 is a perspective view showing a second stator for a reciprocating motor according to a third embodiment of the present invention;

FIG. 7 is a perspective view showing a second stator for a reciprocating motor according to a fourth embodiment of the present invention;

FIG. 8 is a perspective view showing a second stator for a reciprocating motor according to a fifth embodiment of the present invention; and

FIG. 9 is a perspective view showing a second stator for a reciprocating motor according to a sixth embodiment of the present invention.

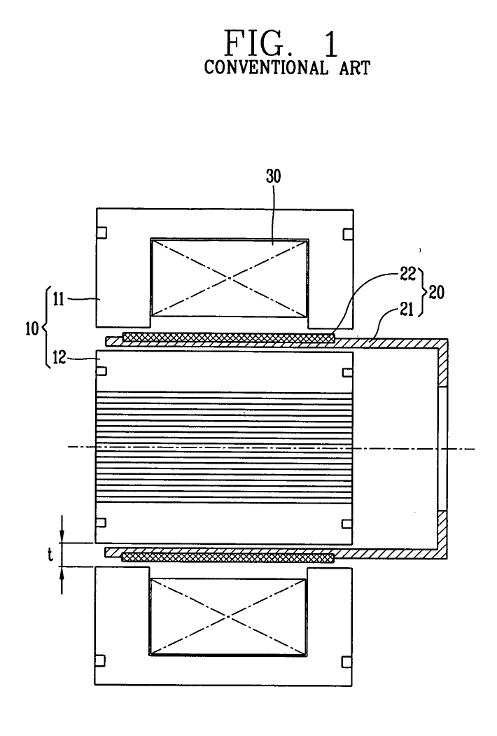

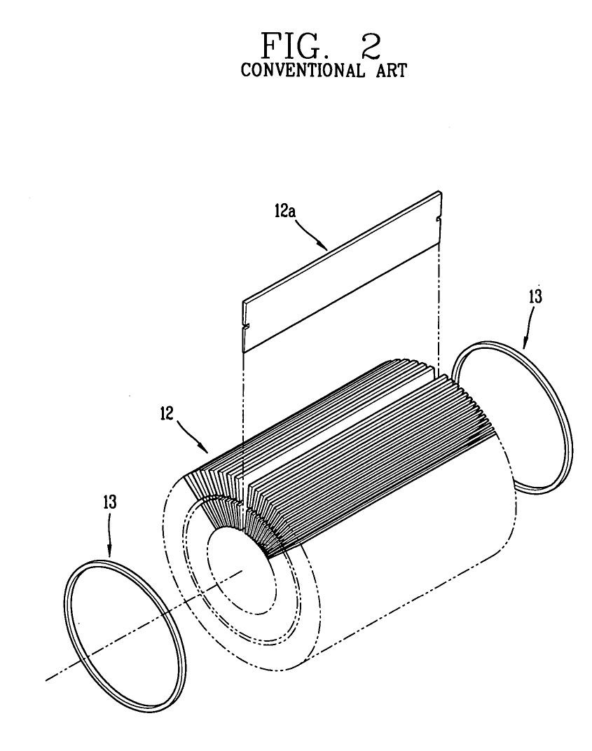

### DETAILED DESCRIPTION OF THE PREFERRED EMBODIMENTS

A stator structure for a reciprocating motor according to the present invention will now be described in detail with reference to embodiments illustrated in the accompanying drawings. A description will be omitted with respect to the parts same as the conventional art.

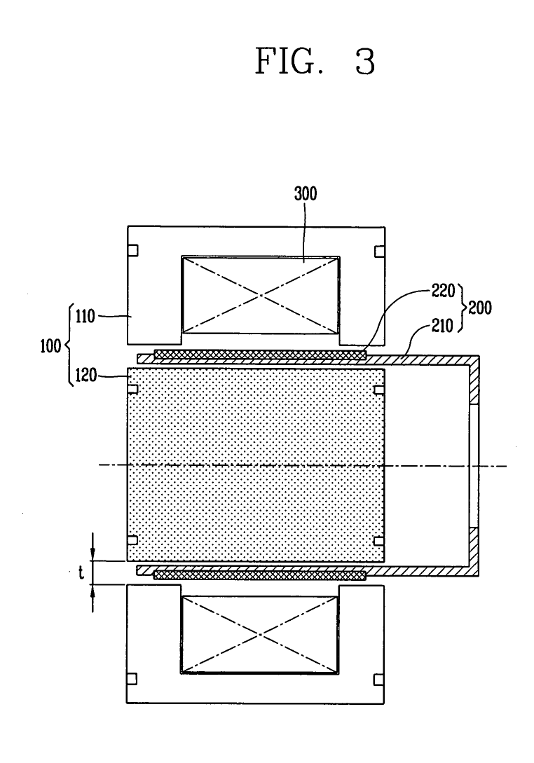

FIG. 3 is a sectional view showing one example of a reciprocating motor according to the present invention. Referring to this, the reciprocating motor of this includes a stator assembly 100 forming a flux and a mover assembly 200 performing linear reciprocating movements by the flux of the stator assembly 100.

The stator assembly 100 consists of a first stator 110 provided with a winding coil 300 and a second stator 120 inserted with a predetermined air gap t from the first stator 110 and molded by powder metallurgy.

The first stator 110 is formed by laminating thin silicon steel sheets of a Π shape in a circumferential direction on the outer circumferential surface of the coil 300 of a ring shape generating a change of the flux.

The mover assembly 200 consists of a mover body 210 movably arranged in an air gap between the outer stator 110 and the inner stator 120 and a plurality of magnets 220 fixed on the outer circumferential surface of the mover assembly 210 with same intervals therebetween.

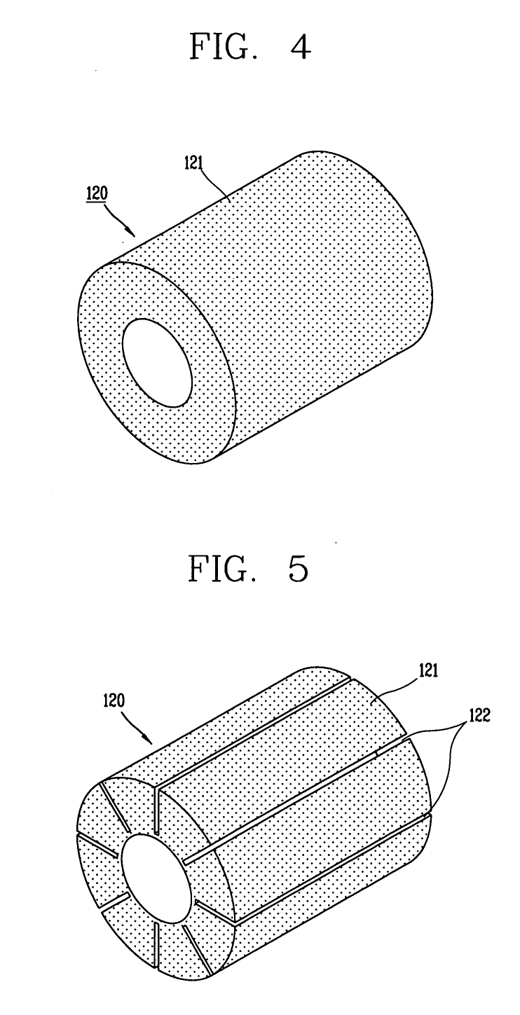

FIG. 4 is a perspective view showing a second stator for a reciprocating motor according to a first embodiment of the present invention.

As illustrated therein, in the second stator 120, the stator body 121 of integral type is formed in a cylindrical shape by powder metallurgy.

Preferably, the powder is a soft magnetic composite (hereinafter, SMC). The SMC is a kind of metal powder, which is a magnetic material with electric and magnetic characteristics improved in order to be applied to an electromagnetic system such as a motor, and is made by compressing a powder of a magnetic material coated with an insulating coating material.

The powder metallurgy is referred to as a processing technique for making a material having a unique property or a product of a given shape using the phenomenon that a metal powder or a compound thereof is hardened when heated at a high temperature.

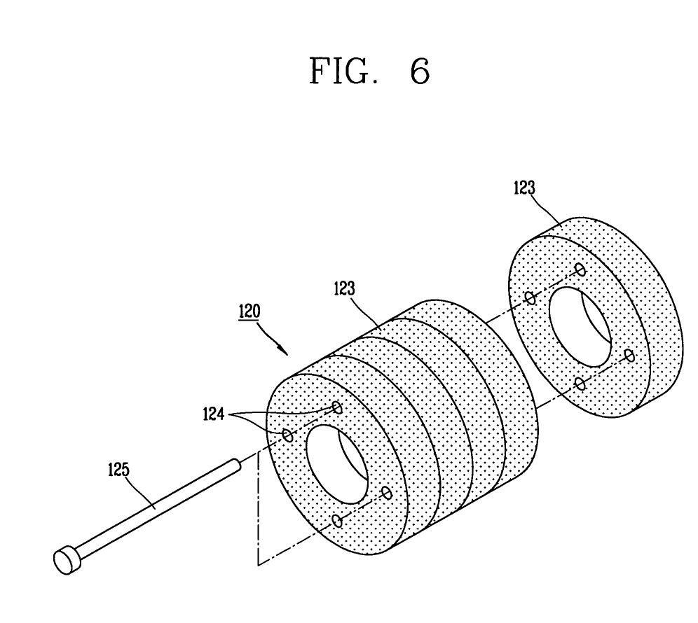

FIG. 5 is a perspective view showing a second stator for a reciprocating motor according to a second embodiment of the present invention.

As illustrated therein, the second stator 120 has several eddy current breaking slits 122 axially split formed on the outer circumferential surface of the stator body 121 of an integral cylindrical shape. When occasion demands, the eddy current breaking slits 122 can be formed on the inner circumferential surface of the stator body 121. The eddy current breaking slits 122 are axially formed in order to decrease eddy current losses caused by eddy currents.

FIG. 6 is a perspective view showing a second stator for a reciprocating motor according to a third embodiment of the present invention.

As illustrated therein, the second stator 120 can be formed by laminating several stator modules 123 of a cylindrical shape having a predetermined height in axial direction. After the lamination, the stator modules 123 are fixed by rivets 125 via rivet holes 124 arranged in circumferential direction.

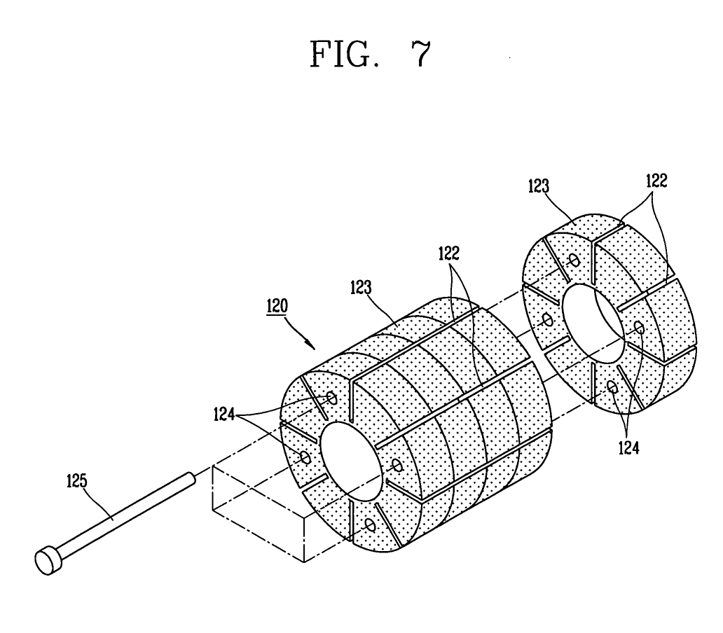

FIG. 7 is a perspective view showing a second stator for a reciprocating motor according to a fourth embodiment of the present invention. As illustrated therein, the second stator 120 is formed by laminating several stator modules 123 of a cylindrical shape having a predetermined height in axial direction, and eddy current breaking slits 122 are axially formed on the outer circumferential surface thereof. When occasion demands, the eddy current breaking slits 122 can be formed on the inner circumferential surfaces of stator modules 123. After the lamination, the stator modules 123 are fixed by rivets 125 via rivet holes 124 arranged in circumferential direction.

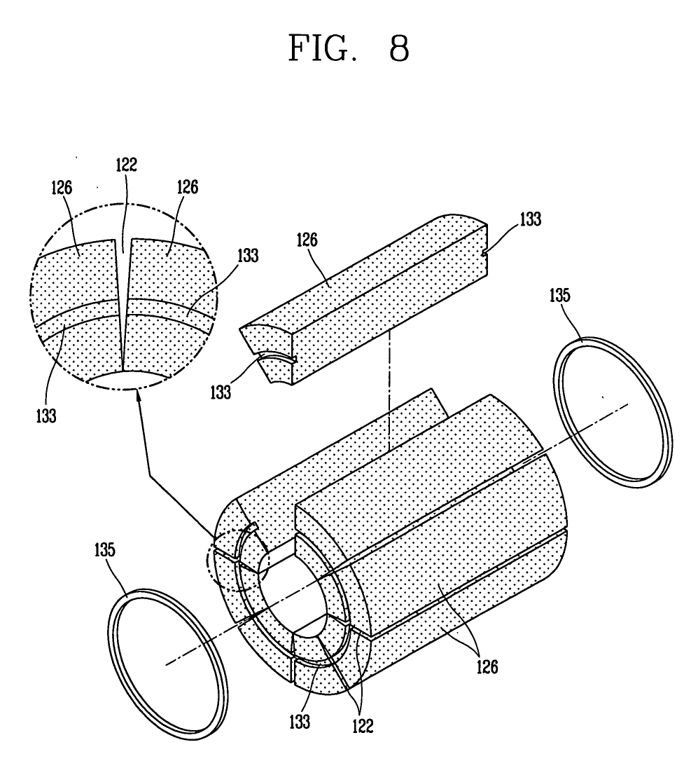

FIG. 8 is a perspective view showing a second stator for a reciprocating motor according to a fifth embodiment of the present invention. As illustrated therein, the second stator 120 is formed by forming stator blocks 126 of a circular arc shape, radially laminating the stator blocks 126 and fixing both sides thereof by fixed rings 135. Fixed ring insertion grooves 133 are formed at the positions corresponding to the fixed rings 135 on axial sections of the fixed blocks 126 so as to couple to the fixed rings 135.

The angle of the inner circumferential arc of the fixed blocks 126 and the angle of the outer circumferential arc thereof are made different so that eddy current breaking slits 122 are formed in the gaps between the fixed blocks 126. That is, the angle of the inner circumferential arc is larger than the angle of the outer circumferential arc.

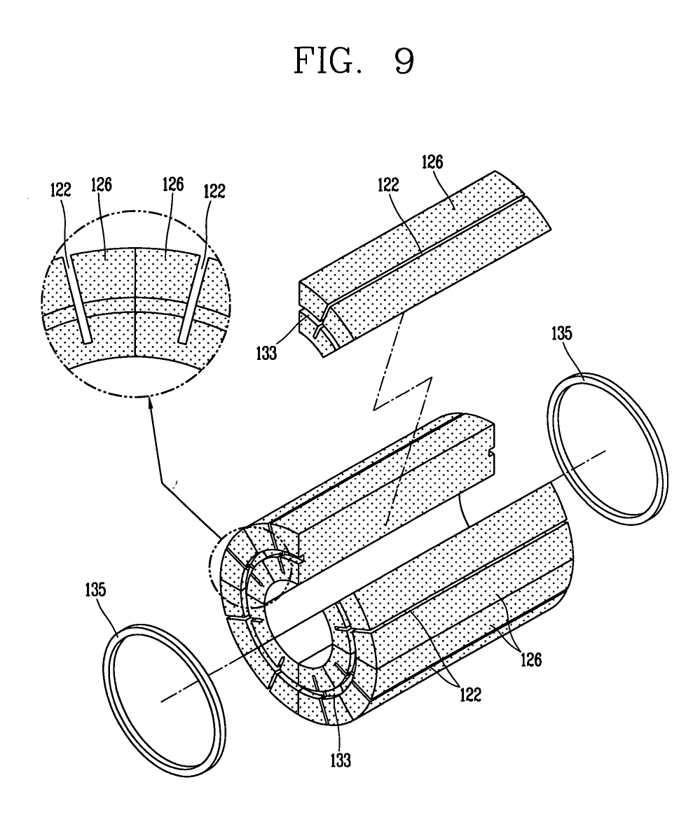

FIG. 9 is a perspective view showing a second stator for a reciprocating motor according to a sixth embodiment of the present invention. As illustrated therein, the second stator 120 is formed by forming stator blocks 126 of a circular arc shape, radially laminating the stator blocks 126 and fixing both sides thereof by fixed rings 135. The different thing from the fifth embodiment is that the fixed blocks 126 are closely adhered to each other because the angle of the inner circumferential arc and the angle of the outer circumferential arc are the same, and eddy current breaking slits 122 are formed separately on the outer circumferential surfaces of the fixed blocks 126. Fixed ring insertion grooves 133 are formed at the positions corresponding to the fixed rings 135 on axial sections of the fixed blocks 126 so as to couple to the fixed rings 135.

Operations and effects of the stator for the reciprocating motor constructed as above will be described as follows.

When an electric power is applied to the winding coil 300, a flux is formed between the first stator 110 and the second stator 120. Then, the mover assembly 200 placed in an air gap between the first stator 110 and the second stator 120 continuously perform reciprocating movements while moving along the direction of the flux.

Herein, the second stator with no coil 300 is molded by powder metallurgy. The inner stator thus fabricated is formed as a single unit or by laminating several stator modules or stator blocks rather than by laminating several hundreds of thin silicon steel sheets in radial direction, whereby fabrication processes can be simple and accordingly production costs of the reciprocating motor can be reduced sharply.

In addition, as the second stator is fabricated in an integral type or fabricated of thick modules or blocks, the sectional area through which the flux passes is increased and the improvement of the motor efficiency can be expected.

1. A stator for a reciprocating motor, comprising:
a first stator provided with a winding coil; and
a second stator inserted with a predetermined air gap from the first stator and molded by powder metallurgy.

2. The stator of claim 1, wherein the powder for molding the second stator is a soft magnetic composite.

3. The stator of claim 1, wherein the second stator is formed in an integral cylindrical shape.

4. The stator of claim 1, wherein the second stator is formed in an integral cylindrical shape and has several eddy current breaking slits axially split formed on the outer circumferential surface thereof.

5. A stator for a reciprocating motor, comprising:
a first stator provided with a winding coil; and
a second stator formed by molding several stator modules of a cylindrical shape having a predetermined height by powder metallurgy, axially laminating the stator modules and fixing them, and inserted with a predetermined air gap from the first stator.

6. The stator of claim 5, wherein the powder for molding the second stator is a soft magnet composite.

7. The stator of claim 6, wherein the stator modules are fixed by rivets penetrating into several rivet holes arranged on the circumference.

8. The stator of claim 5, wherein the stator modules have several eddy current breaking slits axially split formed on the outer circumferential surface thereof.

9. A stator for a reciprocating motor, comprising:
a first stator provided with a winding coil; and
a second stator formed by molding several stator blocks of a cylindrical shape having a predetermined height by powder metallurgy, radially laminating the stator blcoks and fixing them, and inserted with a predetermined air gap from the first stator.

10. The stator of claim 9, wherein the powder for molding the second stator is a soft magnet composite.

11. The stator of claim 9, wherein the stator blocks has fixed ring insertion grooves formed on axial sections thereof for press fitting and fixing fixed rings thereto.

12. The stator of claim 9, wherein the angle of the inner circumferential arc of the fixed blocks and the angle of the outer circumferential arc thereof are made different so that eddy current breaking slits are formed between the fixed blocks.

13. The stator of claim 9, wherein the angle of the inner circumferential arc of the fixed blocks is made larger than the angle of the outer circumferential arc thereof so that eddy current breaking slits are formed between the fixed blocks

14. The stator of claim 9, wherein the stator blocks have several eddy current breaking slits axially split formed on the outer circumferential surface thereof.
